(19) United States
(12) Patent Application Publication
(10) Pub. No.: US 2017/0248454 A1
(43) Pub. Date: Aug. 31, 2017

(54) Ultrasonic Flow Probe And Method Of Monitoring Fluid Flow In A Conduit

(71) Applicant: PCME LIMITED, St Ives, Cambridgeshire (GB)

(72) Inventors: Roger Bradley Millington, St Ives, Cambridgeshire (GB); Archibald Simon Reid, St Ives, Cambridgeshire (GB)

(21) Appl. No.: 15/119,414

(22) PCT Filed: Feb. 13, 2015
(86) PCT No.: PCT/GB2015/050421

§ 371 Date: Aug. 17, 2016

(30) Foreign Application Priority Data
Feb. 18, 2014 (GB) 1402884.9

(51) Int. Cl. G01F 1/66; G01P 5/24

(52) U.S. Cl. CPC G01F 1/662; G01F 1/667; G01P 5/245

(57) ABSTRACT

An ultrasonic flow probe (100) comprising a mounting member (101) for mounting on a surface of a conduit and thereby defining a mounting axis (B) perpendicular to the surface, a frame (103) mounted on the mounting member (101), and a plurality of ultrasonic transducers (105) mounted on the frame (103) and aligned along a primary axis (A); wherein the frame (103) and mounting member (101) are configurable such that the primary axis (A) is at an angle to the mounting axis (B) so that, in use, ultrasound passing between the transducers (105) travels at an angle to fluid flowing in the conduit.

### FIELD OF THE INVENTION

The present invention concerns an ultrasonic flow probe and a method of monitoring fluid flow in a conduit, for example a stack. More particularly, but not exclusively, this invention concerns an ultrasonic flow probe for monitoring fluid flow in a conduit.

### BACKGROUND OF THE INVENTION

It is often desirable to know the characteristics of fluid flow in a conduit, for example a stack. This may be due to a regulatory requirement to monitor emissions, or a desire to improve the efficiency of an industrial process. Characteristics of fluid flow being measured may include: the average velocity of the fluid, the velocity profile of the fluid, and/or any departure from lamina flow within the fluid.

There is a variety of techniques for measuring fluid flow. These include optical methods, electrical methods and ultrasonic methods. In a typical ultrasonic method ultrasonic transducers emit and receive contra-propagating ultrasonic waves along a path, having a component parallel to the fluid flow. The difference in propagation time between the two waves can be related to the average velocity of the fluid along the path between the transducers.

Currently there are a number of apparatuses and methods for ultrasonically measuring particle flow. These include transducers that are installed integrally into the walls of a conduit, transducers which can be clamped onto the outer walls of a conduit, and probes which can be inserted into a conduit.

For example, International patent application publication number WO2013/165670 discloses a spool-piece type flow meter. This flow meter comprises a flow passage through which fluid flow is to be measured. The flow meter has a first transducer and a second transducer inset around the flow passage to transmit and receive ultrasonic energy. The transducers are installed integrally into the walls of the spool-piece. Transducers may also be installed in a similar manner into existing conduits by tapping or drilling into the side of the conduit. Installation and manufacturing cost of spool-piece flow meters can be high. Furthermore, a significant drawback to these types of flow meters is that, without installing and using further pairs of transducers, only one component of fluid flow can be measured.

Clamp-on type flow meters, such as that disclosed in US patent application publication number US2014/0000339, make measurements from the exterior of the conduit. The installation of such flow meters can be relatively simple and cost effective because the flow measurement takes place without the need for contact with the fluid. However, the conduit generally carries a significant level of noise and when the fluid has a very low density, or is a gas, it carries the ultrasonic signal poorly, and the result can be low signal to noise ratios.

Additionally, the aforementioned flow meters will generally only measure the average velocity of fluid flow across the diameter of the conduit. Measuring the velocity at specific locations in the conduit, which may give an indication of turbulent flow, can be achieved only by providing further pairs of transducers or extensively repositioning the transducers.

A flow meter which samples a part of the flow in a conduit, disposed in the form of a probe, such as that disclosed in EP 0 477 419 A1, requires that a mounting port, into the conduit, is at an angle to the conduit, for example 45 degrees.

The present invention seeks to mitigate the above-mentioned problems. Alternatively or additionally, the present invention seeks to provide an improved method and apparatus for using ultrasonic transducers to measure the properties of fluid flow within a conduit.

### SUMMARY OF THE INVENTION

The present invention provides, according to a first aspect, an ultrasonic flow probe comprising: a mounting member for mounting on a surface of a conduit and thereby defining a mounting axis perpendicular to the surface, a frame mounted on the mounting member, and a plurality of ultrasonic transducers mounted on the frame and aligned along a primary axis; wherein the frame and mounting member are configurable such that the primary axis is at an angle to the mounting axis so that, in use, ultrasound passing between the transducers travels at an angle, for example an angle greater than 0 degrees and less than 90 degrees, to fluid flowing in the conduit.

It will be appreciated that the mounting axis is an axis that is perpendicular to the surface when the mounting member is mounted on the surface. The skilled person will appreciate that the mounting axis is therefore determined by the mounting member. It will also be appreciated that the mounting member may be mounted on the surface in a variety of ways. For example, the mounting member may be fixed to the surface. The mounting member may be mounted on the surface by insertion of the mounting member through the surface. The mounting member may then be fixed through the surface, and would thus be understood to be mounted on the surface.

The ultrasonic flow probe, according to the first aspect, can be inserted into a conduit. Fluid flowing in the conduit can flow past the ultrasonic flow probe. Contra-propagating ultrasonic waves can be emitted and received by the two transducers. The time of flight of the ultrasonic waves can then be determined, and the property of the fluid flow can be calculated.

The ultrasonic flow probe, according to the first aspect, will be capable of directly measuring the fluid flow within a conduit. The probe's mounting member may allow it to be mounted on the conduit without the need for a specially-angled spool-piece to be included into the conduit. That may save time and cost during installation of the probe.

The ultrasonic flow probe may have a frame that comprises two arms. An ultrasonic transducer may be mounted to each arm.

The angle between the primary axis and the mounting axis may be in the range of greater than zero degrees and less than 90 degrees. Preferably the angle is in the range greater than 5 degrees to less than 85 degrees, for example in the range greater than 10 degrees to less than 80 degrees, for example in the range greater than 20 degrees to less than 70 degrees. Having an angle in this range advantageously means the path between the two transducers has a component parallel to the fluid flow.

The frame may be mounted to the mounting member such that the angle between the primary axis and the mounting axis is adjustable. This may allow the primary axis to be positioned at the angle to fluid flow which is most preferable for a given application. The angle between the primary axis and mounting axis may be adjustable to a first angle, to permit insertion of the probe into a conduit, and to a second angle, for taking a measurement. This may allow the flow probe to be inserted into conduits of a variety of shapes and sizes. The angle between the primary axis and the mounting axis may be adjustable by an automated actuation system. The actuation system may allow the angle of the primary axis to be remotely altered. This may allow the flow probe to take measurements at a variety of angles. The velocity profile of the fluid may then be determined in the probe's sample region without the need for further pairs of transducers. Furthermore, this may allow measurements to be taken at different angles without interfering with or stopping the fluid flow.

The ultrasonic flow probe may have the angle between the primary axis and the mounting axis fixed. This may reduce the cost of manufacture for applications of the probe where the primary axis is required to be at a specific angle to the mounting axis.

The ultrasonic flow probe may have a frame that can rotate about the mounting axis. This may allow the primary axis to be positioned at an angle to fluid flow which is even more preferable for taking a given measurement. The rotation of the frame about the mounting axis may be adjustable by an actuation system, which may be automated. The actuation system may allow the rotation of the frame about the mounting axis to be remotely altered. This may allow rotation about the mounting axis to take place without interfering with or stopping the fluid flow in the conduit. Rotating the frame about the mounting axis may allow a 3 dimensional velocity profile of the fluid to be built up in the probe's sample region.

The separation of the transducers may be adjustable by an actuation system, which may be automated. The adjustable separation of transducers may allow the sample region of the flow probe to be adjusted to a size which is most preferable for a given application. The separation of the transducers may be adjustable to a first position to permit insertion of the probe into a conduit, and to a second position, for taking a measurement. This may allow the flow probe to be inserted into conduits of a variety of shapes and sizes. The ultrasonic flow probe may comprise an automated actuation system for altering the separation of the transducers. This may allow transducer separation adjustment to take place without interfering with or stopping the fluid flow in the conduit.

The angle between the primary axis and the mounting axis may be configurable to measure specific characteristics of the fluid flow in the conduit. These characteristics may include the velocity profile of the fluid.

According to a second aspect of the invention there is provided a method for monitoring fluid flow in a conduit comprising: providing an ultrasonic flow probe comprising two ultrasonic transducers aligned along a primary axis; inserting the ultrasonic flow probe into the conduit; mounting the ultrasonic flow probe on a surface of the conduit; adjusting the probe such that the primary axis is at an angle to a mounting axis, the mounting axis being perpendicular to the surface; and measuring a property of the fluid flow by: contra-propagating ultrasonic waves between the two transducers; determining the time of flight of the ultrasonic waves; and calculating the property of the fluid flow from the time of flight.

The step of mounting the ultrasonic flow probe on a surface of the conduit may, for example, include mounting the ultrasonic flow probe to or through the surface, which may be an inner surface of the conduit.

Such a method for monitoring fluid flow permits the fluid flow to be measured directly. Thus there is no need for a specially-angled spool-piece to be included into the conduit. This may reduce the time and cost associated with installing the probe. The adjusting of the primary axis to be at an angle to the mounting axis may allow the probe to be positioned at an angle most preferable for a given application. Re-adjustment of the already mounted probe may also be carried out.

The angle between the primary axis and the mounting axis may be adjusted to a value in the range of greater than zero degrees to less than 90 degrees. Thus it may be possible to set the primary axis at an angle to the average velocity of fluid flow. The angle between the primary axis and the mounting axis may be adjusted to zero during insertion of the probe into the conduit, and adjusted to a value greater than zero degrees and less than 90 degrees during the measuring. This may allow insertion of the flow probe into conduits of a variety of shapes and sizes. The angle between the primary axis and the mounting axis may be adjusted by an actuation system, which may be automated. The actuation system may allow the angle of the primary axis to be remotely altered. This may allow measurements to be taken at different angles without interfering with the fluid flow in the conduit in order to alter the angle of the primary axis.

The method may include a step of adjusting the frame by rotating the frame about the mounting axis prior to the measuring. This may allow the primary axis to be positioned at an angle to fluid flow which is even more preferable for a given application. The rotating of the frame about the mounting axis may be carried out by an automated rotation system. This may allow rotation about the mounting axis to take place without interfering with or stopping the fluid flow in the conduit.

The method may include a step of adjusting the separation of the transducers prior to the measuring. The adjustment may be performed by an actuation system, which may be automated. Adjustable separation of the transducers may allow the sample region of the flow probe to be adjusted to a size which is most preferable for a given application. The transducers may be at a first separation during the insertion of the probe into the conduit and adjusted to a second position prior to the measuring. This may allow the flow probe to be inserted into conduits of a variety of shapes and sizes. The altering of the transducer separation may be done from outside of the conduit by an automated actuation system. This may allow the transducer separation adjustment to take place without interfering with or stopping the fluid flow in the conduit.

The method may include adjusting the angle between the primary axis and the mounting axis for measuring specific characteristics of the fluid flow. The measured characteristic may be the velocity profile of the fluid in the conduit. The measuring may include sweeping the primary axis over a range of angles wherein one or more measurements are taken.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only, with reference to the accompanying schematic drawings of which:

FIG. 1 shows a side view of an ultrasonic flow probe according to a first embodiment of the invention;

FIG. 2 shows an end view of the ultrasonic flow probe of FIG. 1; and

FIG. 3 shows a perspective view of the ultrasonic flow probe of FIG. 1.

### DETAILED DESCRIPTION

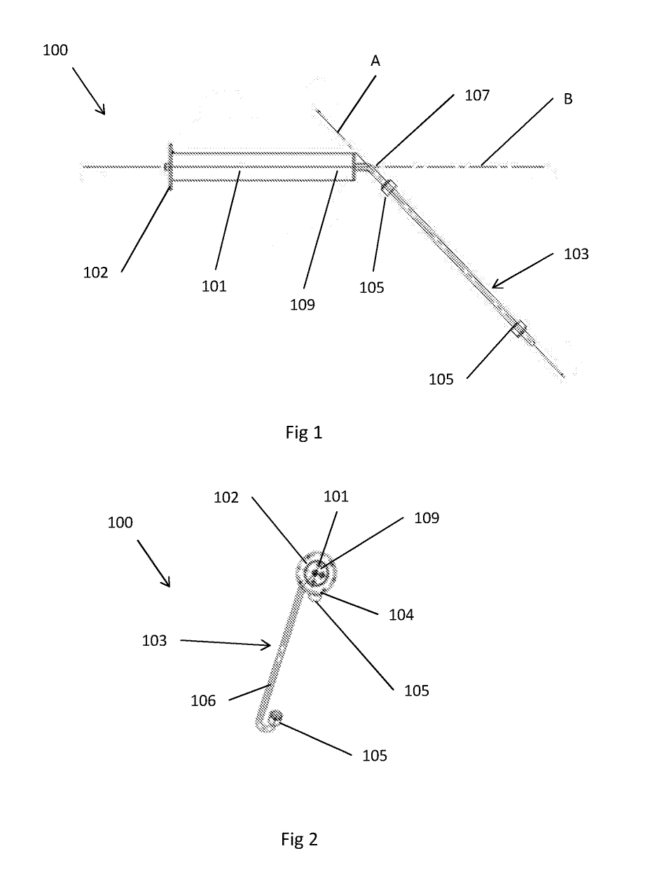

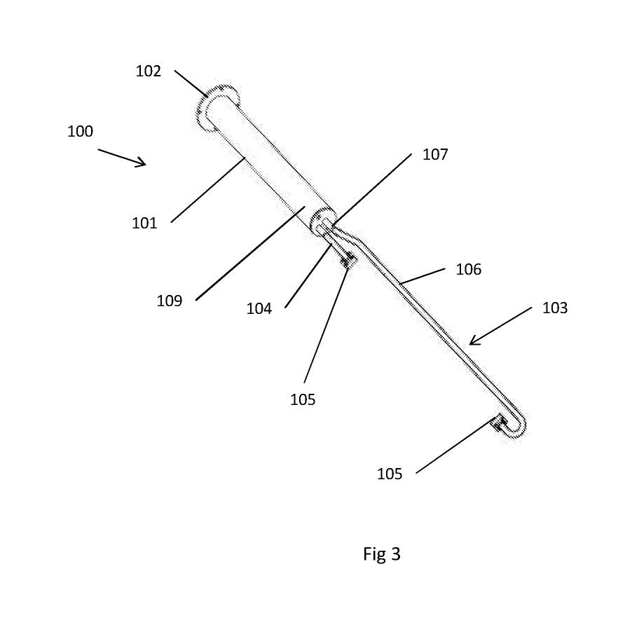

FIGS. 1, 2 and 3 show a first embodiment of an ultrasonic flow probe 100 comprising: a mounting member 101, a frame 103 mounted on the member 101, and two ultrasonic transducers 105 mounted on the frame 103.

The mounting member 101 is a cylindrical member that, when the probe 100 is mounted on a surface, extends away from the surface with the axis of the cylinder being aligned along a mounting axis B. At one end of the mounting member 101 there is a mounting plate 102 which is arranged to be mounted on the surface on which the probe 100 is mounted. For example, the mounting plate 102 may be fixed to or through the surface. Since the mounting plate 102 in this embodiment is aligned with the surface, the mounting axis B is perpendicular to the mounting plate 102.

The frame 103 consists of two arms 104, 106. One end of each arm 104, 106 is mounted to the free end of the mounting member 101. An ultrasonic transducer 105 is mounted to the other end of each arm 104, 106. The transducers 105 are aligned along primary axis A and face each other. The primary axis A is at an angle to the mounting axis B. The first arm 104 extends a short distance parallel to the mounting axis B, the arm 104 then bends and extends a short distance along the primary axis A. A transducer 105 is mounted at the end of the arm 104. The second arm 106 is mounted adjacent to the first arm 104. The second arm extends a short distance parallel to the mounting axis B, the arm 106 then bends and extends parallel to the primary axis A. The second arm 106 extends further from the mounting member than the first arm 104. Distally from the mounted end of the second arm 106, the second arm 106 forms a U-shaped bend, such that the transducer mounted to the second arm 106 faces the transducer mounted on the first arm 104.

Prior to fixing, the mounting plate 102 may be rotated about the axis B in order to locate the axis A at an angle suitable for the required measurement of flow velocity.

Alternatively, an actuation system 109 may be mounted in the end of the mounting member 101. The actuation system 109 controls the rotation of the frame 103 about the mounting axis B.

A member 107 is positioned between the mounting member 101 and the frame 103. The member 107 is an articulated member which permits the angle of axis A to be changed relative to axis B. A second actuation system (not shown) operates on the member 107 and controls the angle between the primary axis A and the mounting axis B. The actuation systems are remotely controlled by a control module or computer (not shown). Appropriate actuation systems will be known to a person skilled in the art.

The flow probe 100 may be mounted on a wall of a conduit, for example by fixing the mounting member 102 to or through the wall. Fluid flowing in the conduit will pass between the two transducers 105. The actuation systems act to set the angle of the primary axis A for an appropriate measurement to take place. In some embodiments of the invention, the actuation systems sweep the frame over a range of angles during which many measurements are taken. During the measurement process, contra-propagating ultrasonic waves are emitted and received by the two transducers 105, the time of flight of the ultrasonic waves is then determined, and a desired property of the fluid flow is calculated.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

Although the above ultrasonic flow probe includes actuation systems, in some embodiments of the invention the ultrasonic flow probe has a fixed frame and mounting member with no actuation systems. In another embodiment the ultrasonic flow probe includes an automated actuation system for controlling the separation of the transducers. The automated actuation system is mounted to the frame and the two ultrasonic transducers are mounted on the actuation system.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. An ultrasonic flow probe comprising:
a mounting member for mounting on a surface of a conduit and thereby defining a mounting axis perpendicular to the surface,
a frame mounted on the mounting member, and
a plurality of ultrasonic transducers mounted on the frame and aligned along a primary axis;
wherein the frame and mounting member are configurable such that the primary axis is at an angle to the mounting axis so that, in use, ultrasound passing between the transducers travels at an angle to fluid flowing in the conduit.

2. An ultrasonic flow probe according to claim 1, wherein the frame comprises two arms, wherein an ultrasonic transducer is mounted on each arm.

3. An ultrasonic flow probe according to claim 1, wherein the angle between the primary axis and the mounting axis is in the range from greater than zero degrees to less than 90 degrees.

4. An ultrasonic flow probe according to claim 1, wherein the frame is mounted on the mounting member such that the angle between the primary axis and the mounting axis is adjustable.

5. An ultrasonic flow probe according to claim 1, wherein the angle between the primary axis and mounting axis is adjustable to a first angle, to permit insertion of the probe into a conduit, and to a second angle, for taking a measurement.

6. An ultrasonic flow probe according to claim 1, wherein the ultrasonic flow probe comprises an actuation system for adjusting the angle between the primary axis and the mounting axis.

7. An ultrasonic flow probe according to claim 1 wherein the angle between the primary axis and the mounting axis is fixed.

8. An ultrasonic flow probe according to claim 1 wherein the frame can rotate about the mounting axis.

9. An ultrasonic flow probe according to claim 8, where the rotation of the frame about the mounting axis is automated.

10. An ultrasonic flow probe according to claim 1 wherein the ultrasonic flow probe comprises an actuation system for adjusting the separation of the transducers.

11. An ultrasonic flow probe according to claim 10 wherein the separation of the transducers is adjustable to a first separation to permit insertion of the probe into a conduit, and to a second separation, for taking a measurement.

12. An ultrasonic flow probe according to claim 1 wherein the flow probe comprises an automated actuation system for altering the separation of the transducers.

13. An ultrasonic flow probe according to claim 1 wherein the angle between the primary axis and mounting axis is configurable to measure specific characteristics of a fluid flow in a conduit.

14. An ultrasonic flow probe according to claim 1 wherein the angle between the primary axis and the mounting axis is configurable to measure the velocity profile of a fluid.

15. A method for monitoring fluid flow in a conduit comprising:
providing an ultrasonic flow probe comprising two ultrasonic transducers aligned along a primary axis;
inserting the ultrasonic flow probe into the conduit;
mounting the ultrasonic flow probe on a surface of the conduit;
adjusting the probe such that the primary axis is at an angle to a mounting axis, the mounting axis being perpendicular to the surface; and
measuring a property of the fluid flow by:
contra-propagating ultrasonic waves between the two transducers;
determining the time of flight of the ultrasonic waves; and
calculating the property of the fluid flow from the time of flight.

16. A method according to claim 15, wherein the angle between the primary axis and the mounting axis is adjusted to a value greater than zero degrees to less than 90 degrees.

17. A method according to claim 16 wherein the angle between the primary axis and the mounting axis is zero during insertion of the probe into the conduit, and a value greater than zero degrees to less than 90 degrees during the measuring.

18. A method according to claim 15, wherein the angle between the primary axis and the mounting axis is adjusted by an actuation system.

19. A method according to claim 15, wherein the probe is adjusted by rotation of the frame about the mounting axis prior to the measuring.

20. A method according to claim 19, wherein the frame is rotated about the mounting axis by an automated rotation system.

21. A method according to claim 15, wherein separation of the transducers is adjusted by an actuation system prior to the measuring.

22. A method according to claim 15, wherein the transducers are at a first separation during the insertion of the probe into the conduit and are adjusted to a second position prior to the measuring.

23. A method according to claim 21, wherein the separation of the transducers is altered by an automated actuation system that receives input from outside of the conduit.

24. A method according to claim 15, wherein the angle between the primary axis and the mounting axis is configured to measure specific characteristics of the fluid flow.

25. A method according to claim 15, wherein the primary axis is swept through a range of angles over which one or more measurements are taken.

26. A method according to claim 15, wherein a velocity profile of a fluid in a conduit is measured.

27-28. (canceled)
